(19) United States
(12) Patent Application Publication
(10) Pub. No.: US 2025/0196170 A1
(43) Pub. Date: Jun. 19, 2025

(54) PORTABLE ELECTRONIC SPRAYER

(71) Applicant: simplehuman, LLC, Torrance, CA (US)

(72) Inventors: Frank Yang, Palos Verdes Estates, CA (US); Cory Bowman, Mission Viejo, CA (US); Ryan Wong, Long Beach, CA (US); William Conley, Long Beach, CA (US); Yan Pui Chan, Alhambra, CA (US); Nasser Pirshafiey, Trabuco Canyon, CA (US)

(21) Appl. No.: 18/979,350

(22) Filed: Dec. 12, 2024

Related U.S. Application Data
(60) Provisional application No. 63/609,793, filed on Dec. 13, 2023.
(60) Provisional application No. 63/566,160, filed on Mar. 15, 2024.

(51) Int. Cl. B05B 9/08; B05B 12/16

(52) U.S. Cl. CPC B05B 9/0861; B05B 12/16

(57) ABSTRACT

A household sprayer may include a liquid reservoir configured to store a liquid and a nozzle connected to the liquid reservoir, wherein the nozzle is configured to spray liquid. A household sprayer may include a nozzle actuator connected to the nozzle, wherein the nozzle actuator is configured to control the spray profile of liquid exiting the nozzle, and a pump connected to the nozzle and the liquid reservoir, wherein the pump is configured to cause liquid to flow from the liquid reservoir to the nozzle. A household sprayer may include a battery electrically connected to the pump, wherein the battery is configured to provide power to the pump. A household sprayer may include an outer housing enclosing the liquid reservoir, the pump, and the battery and a sensor disposed beneath the outer housing, wherein activating the sensor causes the pump to activate, thereby causing liquid to spray from the nozzle.

### CROSS REFERENCE

This application claims priority to U.S. Provisional Application No. 63/609,793, filed on Dec. 13, 2023, and U.S. Provisional Application No. 63/566,160, filed on Mar. 15, 2024, the disclosures of each of which are incorporated herein by reference in their entireties for all purposes. Any and all applications for which a foreign or domestic priority claim is identified in the Application Data Sheet as filed with the present application are hereby incorporated herein by reference in their entirety under 37 CFR 1.57 for all purposes.

### BACKGROUND

### Field of the Invention

This disclosure relates generally to systems and methods for spraying liquid.

### Description of the Related Art

Household sprayers can be filled with liquid such as water, cleaning solution, or sanitizer. Typically, a household sprayer has a trigger that is manually pulled to create a force that drives a pump to cause fluid to be transmitted via a nozzle. Additionally, a typical household sprayer has a nozzle control that requires multiple complete turns to adjust from the least restrictive spray profile to the most restrictive spray profile.

### SUMMARY

In some embodiments, a portable household or consumer sprayer, can include a liquid reservoir configured to store a liquid; a nozzle connected to the liquid reservoir, wherein the nozzle is configured to spray liquid; a nozzle actuator connected to the nozzle, wherein the nozzle actuator is configured to control the spray profile of liquid exiting the nozzle; a pump connected to the nozzle and the liquid reservoir, wherein the pump is configured to cause liquid to flow from the liquid reservoir to the nozzle; a battery electrically connected to the pump, wherein the battery is configured to provide power to the pump; an outer housing enclosing the liquid reservoir, the pump, and the battery; and a sensor disposed beneath the outer housing, wherein activating the sensor causes the pump to activate, thereby causing liquid to spray from the nozzle.

In some embodiments, a sprayer can include a sensor disposed underneath the outer housing at a location of a neck region of the sprayer.

Some embodiments described herein relate to a sprayer with a sensor configured to activate when a user contacts the neck of the outer housing or applies a pressure to the neck of the outer housing.

Some embodiments described herein relate to a sprayer with a sensor that includes a spring and a metal plate, wherein the spring is disposed between the outer housing and the metal plate.

In some aspects, the techniques described herein relate to a sprayer, wherein contacting the outer housing causes the spring to contact the metal plate, thereby causing the sensor to activate.

In some aspects, the techniques described herein relate to a sprayer, wherein the nozzle actuator controls the spray profile of the liquid exiting the nozzle by restricting the flow of liquid to the nozzle.

In some aspects, the techniques described herein relate to a sprayer, wherein the nozzle actuator is able to rotate about 45° between two positions.

In some aspects, the techniques described herein relate to a sprayer, wherein the nozzle actuator includes a multi-start thread, wherein the multi-start thread is configured to allow the nozzle to produce a least restrictive spray profile when the nozzle actuator is in a first position and a most restrictive spray profile when the nozzle actuator is in a second position.

In some aspects, the techniques described herein relate to a sprayer, wherein the battery is connected to a base of the sprayer.

In some aspects, the techniques described herein relate to a sprayer, wherein the liquid reservoir is molded such that the battery is partially enclosed by the liquid reservoir.

In some aspects, the techniques described herein relate to a sprayer, wherein the battery is connected to the base of the sprayer at a central location of the base.

In some aspects, the techniques described herein relate to a method for operating a battery-powered sprayer, including, applying a pressure to an outer housing of a sprayer; sensing the pressure applied to the outer housing of the sprayer, via a sensor located beneath the outer housing; sending a signal to a pump, via the sensor; activating the pump, via the signal, wherein activating the pump causes liquid to flow from a liquid reservoir of the sprayer to a nozzle of the sprayer; and spraying liquid from the nozzle.

In some aspects, the techniques described herein relate to a method, further including adjusting the spray profile of the nozzle, via a nozzle actuator.

In some aspects, the techniques described herein relate to a method, wherein adjusting the spray profile of the nozzle includes rotating the nozzle actuator between a plurality of positions.

In some aspects, the techniques described herein relate to a method, wherein the rotating the nozzle actuator to a first position causes the spray profile to be the least restrictive.

In some aspects, the techniques described herein relate to a method, wherein rotating the nozzle actuator to a final position causes the spray profile to be the most restrictive.

In some aspects, the techniques described herein relate to a method, wherein applying a pressure to the outer housing of the sprayer includes applying a pressure to the neck of the outer housing.

In some aspects, the techniques described herein relate to a method, wherein applying a pressure to the outer housing of the sprayer includes contacting the outer housing of the sprayer.

In some aspects, the techniques described herein relate to a method, wherein sending a signal to the pump, via a sensor includes: sending a signal to a battery connected to the pump, via the sensor, when the sensor activates; and transferring electrical power from the battery to the pump.

In some aspects, the techniques described herein relate to a method, wherein activating the pump includes: receiving electrical power, via the pump, from the battery; and activating the pump, upon receiving electrical power from the battery.

### BRIEF DESCRIPTION OF THE DRAWINGS

The detailed description is set forth with reference to the accompanying figures. The use of the same numbers in different figures indicates similar or identical items.

For this discussion, the devices and systems illustrated in the figures are shown as having a multiplicity of components. Various implementations of devices and/or systems, as described herein, may include fewer components, and remain within the scope of the disclosure. Alternatively, other implementations of devices and/or systems may include additional components, or various combinations of the described components, and remain within the scope of the disclosure.

FIG. 1 shows a front isometric view of an electronic sprayer.

FIG. 2 shows a side view of an electronic sprayer.

FIG. 3 shows a top view of an electronic sprayer with the cover of the head removed.

FIG. 4 shows a bottom front isometric view of an electronic sprayer.

FIG. 5 shows a front isometric view of the electronic sprayer with the outer housing removed.

FIG. 6 shows a side view of the sprayer with the outer housing removed.

FIG. 7 shows a zoomed in view of a side view of the sprayer with the outer housing removed.

FIG. 8 shows a front isometric view of the internal reservoir.

FIG. 9 shows a bottom isometric view of the head of the electronic sprayer.

FIG. 10 shows a bottom view of the head of the electronic sprayer.

FIG. 11 shows a bottom view of the head of the electronic sprayer with the nozzle actuator removed.

FIG. 12A is a top view of a nozzle for an electronic sprayer.

FIG. 12B shows a bottom view of a nozzle for an electronic sprayer.

FIG. 13A is a top view of another nozzle for an electronic sprayer.

FIG. 13B is a side view of another nozzle for an electronic sprayer.

FIG. 14A shows a bottom view of the head of the electronic sprayer.

FIG. 14B shows a bottom view of the head of the electronic sprayer with the nozzle actuator removed.

FIG. 15A shows a rear isometric view of a nozzle for an electronic sprayer.

FIG. 15B shows a front isometric view of a nozzle for an electronic sprayer.

FIG. 15C shows a side view of a nozzle for an electronic sprayer.

FIG. 16A shows a side view of a shuttle for an electronic sprayer.

FIG. 16B shows a rear isometric view of a shuttle for an electronic sprayer.

FIG. 16C shows a front isometric view of a shuttle for an electronic sprayer.

FIG. 16D shows a front view of a shuttle for an electronic sprayer.

FIG. 17A shows a rear isometric view of a nozzle actuator for an electronic sprayer.

FIG. 17B shows a front isometric view of a nozzle actuator for an electronic sprayer.

FIG. 17C shows a rear view of a nozzle actuator for an electronic sprayer.

FIG. 17D shows a side cross-sectional view of a nozzle actuator for an electronic sprayer.

FIG. 18 shows a front isometric view of the base of the electronic sprayer.

### DETAILED DESCRIPTION

This specification provides textual descriptions and illustrations of many devices, components, assemblies, and subassemblies. Any structure, material, function, method, or step that is described and/or illustrated in one example can be used by itself or with or instead of any structure, material, function, method, or step that is described and/or illustrated in another example or used in this field. The text and drawings merely provide examples and should not be interpreted as limiting or exclusive. No feature disclosed in this application is considered critical or indispensable. The relative sizes and proportions of the components illustrated in the drawings form part of the supporting disclosure of this specification, but should not be considered to limit any claim unless recited in such claim.

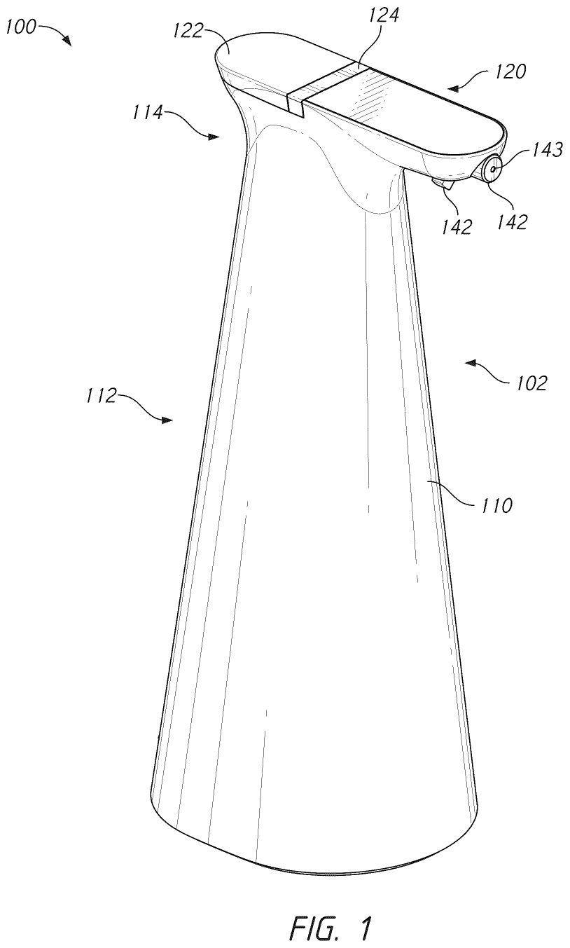

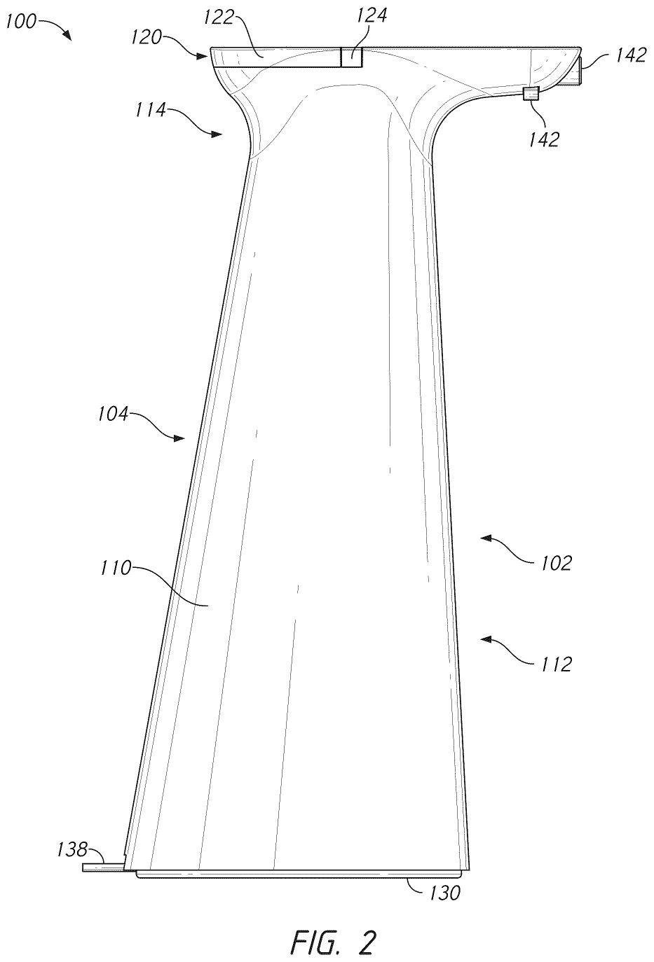

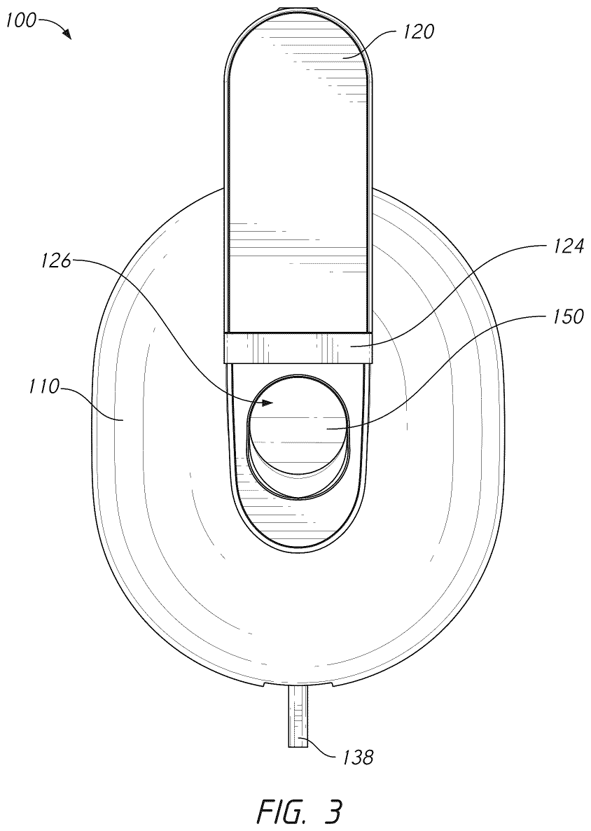

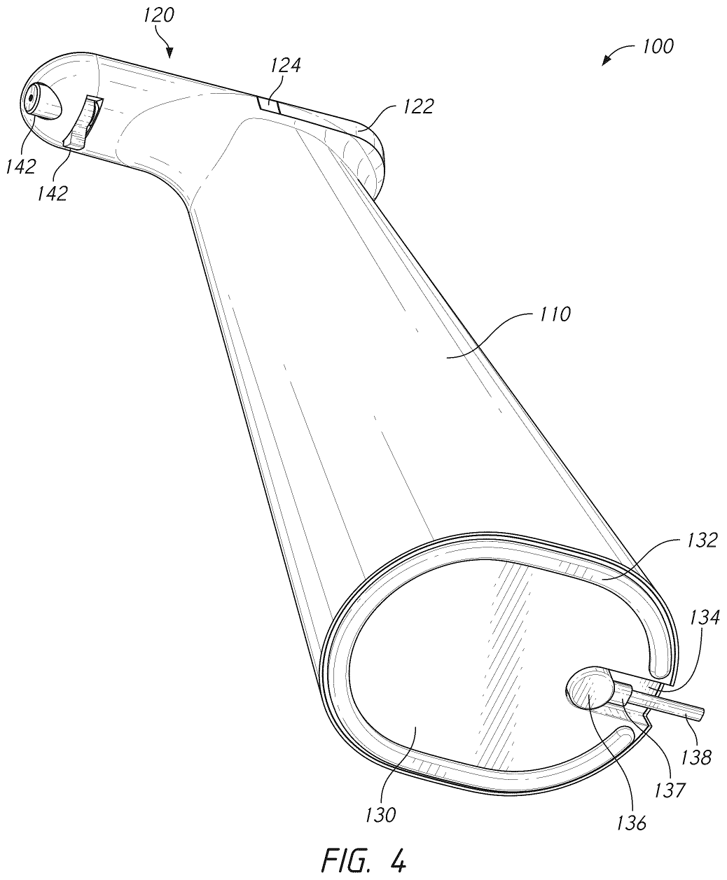

FIGS. 1-4 show various views of an electronic sprayer. FIG. 1 shows a front isometric view of an electronic sprayer 100. FIG. 2 shows a side view of an electronic sprayer 100. FIG. 3 shows a top view of an electronic sprayer 100 with the cover 122 of the head 120 removed. FIG. 4 shows a bottom front isometric view of an electronic sprayer 100.

In some embodiments, the electronic sprayer 100 may comprise an outer housing 110, a head 120, and a nozzle 140. As seen in FIG. 1, the outer housing 110 may have a body 112 and a neck 114. In some embodiments, the body 112 and the neck 114 are integrally formed. The body 112 of the outer housing 110 may be substantially cone-like in shape. In some embodiments, the body 112 of the outer housing 110 may have the form of an oblique cone. In some embodiments, the body 112 of the outer housing 110 forms a frustrum of an oblique cone. In some embodiments, the housing 110 tapers outwardly from top to bottom such that the bottom portion of the outer surface of the housing 110 is substantially wider than the top portion of the outer surface housing (e.g., at least about twice as wide at the bottom as at the top). As shown, the widest and largest cross-sectional region of the sprayer 100 can be the bottom surface. This shape can provide vertical stability and resist tipping or rocking by providing a low center of mass or gravity of the sprayer 100. The majority of the outer surface area of the housing can comprise a smooth, slanted, and/or continuously tapering surface. For example, in some embodiments, the entire outer surface of the outer housing 110 beginning just below the nozzle can be smooth and continuously taper outwardly to the bottom of the outer housing 110. A majority of the outer surface of the housing can comprise an integral, single piece of material that encloses the liquid reservoir and pump (including motor). As illustrated, in some embodiments, all components of the sprayer 100, including the liquid reservoir, the pump (including motor), battery, electronic controller, nozzle, nozzle actuator, sensor, and tubing are contained within the same housing 110. As shown, the components of the sprayer can be stacked or arranged in a generally vertical order such that, for example, the liquid reservoir is entirely below the nozzle actuator, sensor, and motor, and the nozzle actuator, sensor, and motor in turn are entirely below the nozzle. The top of the user grasping portion at the neck of the sprayer 100 on the outside of the housing 110 can be positioned above the top of the liquid reservoir within the housing 110. In some embodiments, as illustrated, a single imaginary vertical line can intersect each of the liquid reservoir, the interior of the grasping portion, and the pump. As shown, in some embodiments, the user grasping portion is at the neck of the housing and there is not a separate handle for the user to grasp that is positioned vertically apart from, or vertically away from, or out of vertical alignment with, the portion of the housing that contains the liquid reservoir. This generally vertical stacking of components can avoid creating a significant torque on the wrist of a user while holding the sprayer 100, which can diminish the strain experienced by a user (as may otherwise occur with a substantially horizontal, gun-type arrangement of components).

As seen in FIG. 2, on a front side 102 of the electronic sprayer 100, the body 112 may be substantially vertical when the electronic sprayer 100 is disposed on the base 130. On a back side 104 of the electronic sprayer 100, the body 112 may be substantially slanted.

As seen in FIG. 2, the outer housing 110 may be shaped such that the outer housing 110 may be disposed against the head 120 of the electronic sprayer 100 with small gaps or openings formed between the outer housing 110 and the head 120.

The outer housing 110 may comprise a plurality of openings on a front side of the outer housing 110. One or more of the plurality of openings may be configured such that a nozzle actuator 142 of the electronic sprayer 100 may be disposed through the openings.

The neck 114 of the outer housing 110 may form an indent on the electronic sprayer 100 between the head 120 of the sprayer 100 and the body 112 of the outer housing 110. The indent may be ideally shaped such that a user can grip the electronic sprayer 100 with the use of a single hand.

The head 120 of the electronic sprayer 100 may be substantially oval like in shape. In some embodiments, the head 120 is substantially flat on its upper surface. This may be beneficial for storing the electronic sprayer 100 on the head 120 of the sprayer 100 without the electronic sprayer 100 falling over. In some embodiments, the head 120 of the sprayer 100 may comprise a cover 122 and a tab 124.

The cover 122 of the head 120 may be removable from the head 120. In some embodiments, the cover 122 may be magnetically connected to the head 120 of the sprayer 100. In some embodiments, the cover 122 may be easily and conveniently removed by sliding or otherwise removing the cover 122 off of the head 120 by applying a force in opposition to the magnetic retaining force. In some embodiments, as shown, none of the nozzle, pump (including motor), sensor 160, battery 170, or housing 110 (beside the cover 122) are removable or separable from the reservoir 156, or the assembly comprising the reservoir, by the consumer in normal use (without the use of tools or breakage). In some embodiments, as shown, the reservoir 150 is not disconnectable, removable, detachable, or separable from the housing 110 (beside the cover 122) and/or from any component(s) within or on the housing (e.g., the nozzle, the pump, the battery, etc.) by a consumer in normal use (without the use of tools or breakage).

As seen in FIG. 3, the head 120 may comprise an opening 126 configured to be used in inserting liquid into the sprayer 100. The opening 126 may be connected to or in fluid communication with a liquid reservoir 150 of the electronic sprayer 100. When the cover 122 is removed from the head 120 of the electronic sprayer 100, the opening 126 can be exposed and liquid can be poured into the opening 126 so that the liquid can enter the liquid reservoir 150 through the opening 126. In some embodiments, the cover 122 may comprise a protrusion configured to engage with the opening 126 thereby securing the cover 122 to the head 120. In some embodiments, the liquid-inserting opening 126 can be positioned in a top region of the sprayer 100, such as on a top-most edge of the sprayer 100 as shown in the illustrated example. By hiding or positioning the liquid-inserting opening 126 behind the cover 122, the outer surface of the sprayer 100 can be smooth and uninterrupted, without any exposed protrusions or recesses needed for filling the sprayer 100. This produces a desirable design aesthetic as well as providing smooth surface area to grasp or carry the sprayer 100.

As seen in FIG. 1, the tab 124 may be substantially rectangular in shape and may be disposed adjacent to the cover 122 of the head 120. In some embodiments, the tab 124 is removably secured, such as by magnet force, to the head 120. In some situations, a plurality of removably securable tabs 124 can be provided. One or more of the tabs 124 can include one of a plurality of indicators to help temporarily and changeably indicate the liquid contents of the sprayer 100. For example, when the sprayer 100 is filled with water, a tab 124 can be attached by the user that includes the word “water” and/or that includes a color and/or a shape to indicate water (e.g., a blue droplet). Additional examples of a plurality of tabs 124 can include indicators for disinfectant, window cleaner, detergent, soapy water, hair spray, or plant fertilizing solution. In some embodiments, rather than providing removable tabs, a wireless or wired interface can electronically communicate with an electronic display positioned on the sprayer 100 that can be changeable by a user via an app on a mobile device to specify or indicate the contents of the sprayer 100. In some embodiments, the electronic display can be an illuminated screen requiring a continuous current of electricity to produce the display, or the electronic display can be an “electronic paper” or “e-ink” display that can use electricity to set a display and then continue displaying that display essentially indefinitely without an additional current of electricity.

As seen in FIG. 4, the outer housing 110 may have an opening wherein a base 130 of the electronic sprayer 100 is disposed. The base 130 may be substantially oval like in shape. In some embodiments, the base 130 may comprise a raised edge 132, a depressed portion 134, and a charging disc 136.

As seen in FIG. 4, the raised edge 132 of the base 130 may be formed on the perimeter of the base 130. In some embodiments, the raised edge extends along at least a portion of the perimeter of the base 130. In some embodiments, the raised edge 132 extends along substantially all of the perimeter of the base 130. In some embodiments, the raised edge 132 may be composed of a rubberlike material. In some embodiments, the raised edge 132 forms a seal between the raised edge 132 and a surface that the electronic sprayer 100 is disposed on. In some embodiments, the raised edge 132 prevents water from seeping under the sprayer 100. In some embodiments, the raised edge 132 is beneficial for preventing liquid from contacting the charging disc 136.

The depressed portion 134 of the base 130 is configured such that the charging disc 136 may be disposed within the depressed portion 134. In some embodiments, the charging disc 136 is disposed within the depressed portion 134 such that the charging disc 136 does not contact the surface that the electronic sprayer 100 is disposed on. In some embodiments, the charging disc 136 is disposed within the depressed portion 134 such that when the sprayer 100 is disposed on a wet surface the charging disc 136 does not contact the liquid or wet surface. In some embodiments, the depth of the depressed portion 134 may be substantially similar to the height of the charging disc 136.

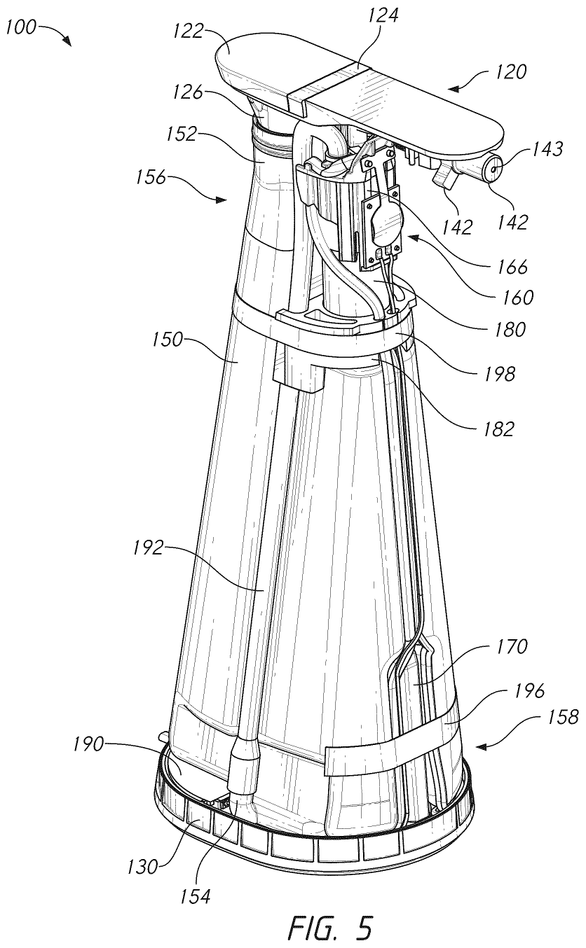

In some embodiments, the sprayer 100 can be portable, meaning that: it can include an onboard battery to enable the sprayer 100 to function fully without attachment to one or more external electrical wires during use; the entire sprayer 100 as a unit with the pump (including motor) and liquid reservoir can be lightweight so as to be comfortably and casily held and actuated with one hand, and comfortably and easily aimed by pivoting the user's wrist (e.g., less than or equal to about 2 pounds/less than or equal to about one kilogram); and the entire sprayer 100 as a unit can be sufficiently small in length and circumference or perimeter so as to be comfortably and easily graspable and usable with one hand (e.g., less than or equal to about 18 inches in maximum length and less than or equal to about 16 inches in maximum circumference or perimeter). As seen in FIG. 4, the charging disc 136 may be disposed within the depressed portion 134 of the base 130. The charging disc 136 may be substantially round in shape and may be electrically connected to the battery 170 (as seen in FIG. 5) of the electronic sprayer 100. In some embodiments, the charging disc 136 is configured to supply electrical power to the battery 170. In some embodiments, the charging disc 136 provides power to the battery 170 in the form of an alternating current or in the form of a direct current. In some embodiments, the charging disc 136 charges the battery 170 at a constant rate. In some embodiments, the charging disc 136 is configured to charge the battery 170 when the battery 170 drops below a threshold charge value. The charging disc 136 may additionally be electrically connected to a power supply, via a cable 138. In some embodiments, the power supply may be the electrical system of a building.

In some embodiments, the charging disc 136 may be detachable from the base 130 of the sprayer 100. In some embodiments, the charging disc 136 may comprise a USB port 137. The cable 138 may be connected to the charging disc 136 via the USB port 137. In some embodiments, the cable 138 can be unplugged from the charging disc 136, thereby allowing the electronic sprayer 100 to be operated without being affixed to the cable 138.

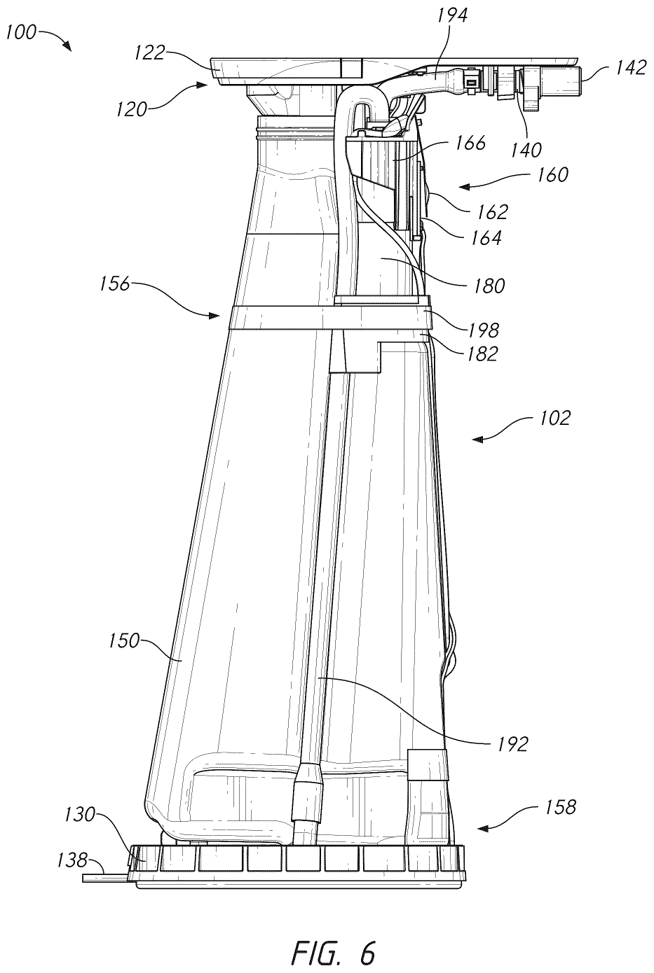

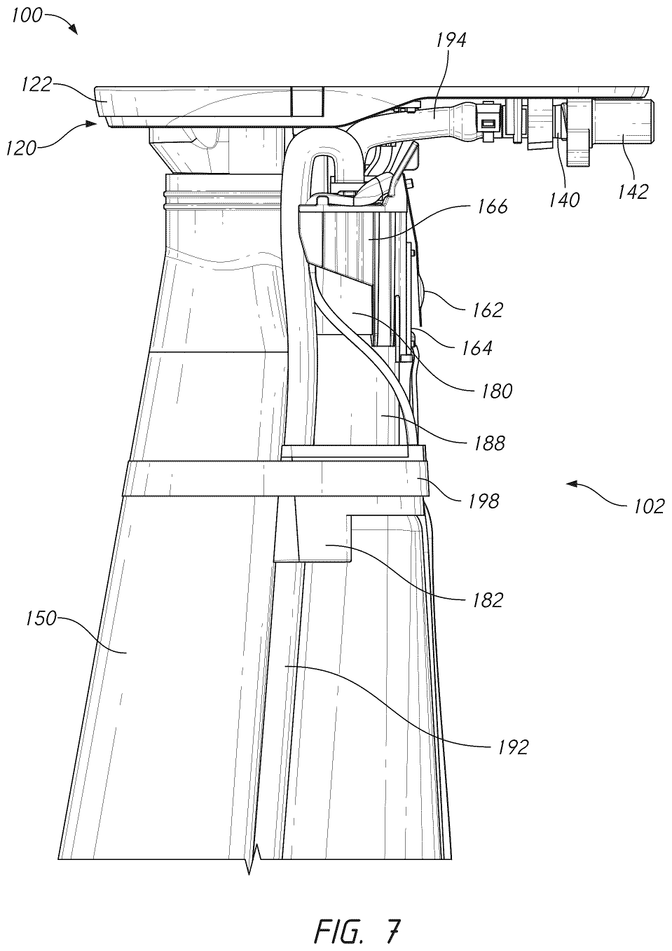

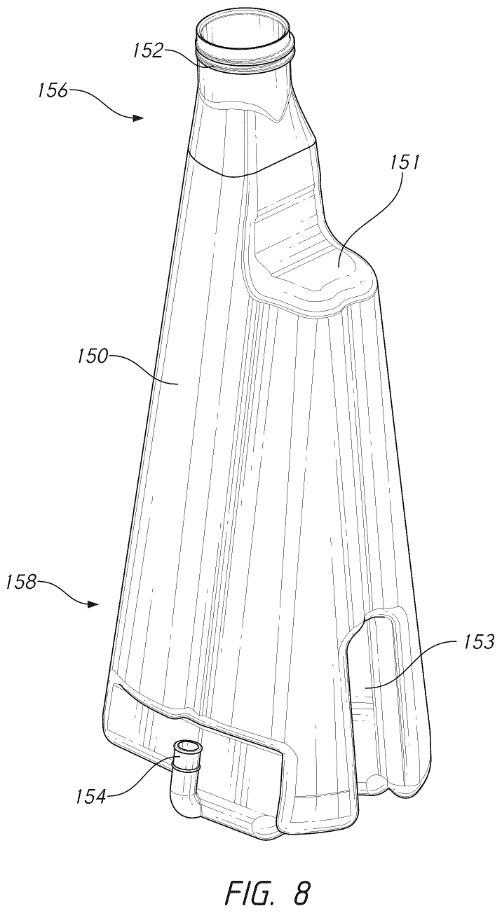

FIGS. 5-8 shows views of the electronic sprayer 100 with the outer housing 110 of the sprayer 100 removed in order to see the internal components more clearly. FIG. 5 shows a front isometric view of the electronic sprayer 100 with the outer housing 110 removed. FIG. 6 shows a side view of the sprayer 100 with the outer housing 110 removed. FIG. 7 shows a zoomed-in view of FIG. 6. FIG. 8 shows a front isometric view of the liquid reservoir 150.

As seen in FIGS. 6-8, the electronic sprayer 100 comprises a liquid reservoir 150, a sensor 160, a battery 170, and a pump 180. The liquid reservoir 150 is disposed within the outer housing 110. The liquid reservoir 150 may be shaped similarly to the outer housing 110 and may be disposed on the base 130 of the sprayer 100. The liquid reservoir 150 may comprise a fluid inlet 152 and a fluid outlet 154. In some embodiments, the liquid reservoir 150 has the capacity to store up to about ½ gallon of water. In some embodiments, the liquid reservoir 150 has the capacity to store up to about 1 gallon of water.

The fluid inlet 152 may be positioned at a top portion 156 of the liquid reservoir 150. The fluid inlet 152 may be connected to the head 120 of the sprayer 100 such the opening 126 is in fluid communication with the liquid reservoir 150. The fluid inlet 152 may be secured to the head 120 via a connector such as a threaded screwing attachment or a friction-fit or snap fit.

The fluid outlet 154 may be positioned on a bottom portion 158 of the liquid reservoir 150. The fluid outlet 154 is in fluid communication with the pump 180. When the pump 180 is activated, fluid flows from the liquid reservoir 150 through the fluid outlet 154 to the pump 180. In some embodiments, the fluid outlet 154 is fluidly connected to the pump 180 via a first tube 192.

As seen in FIG. 8, the liquid reservoir 150 may additionally comprise a shelf 151 and a recess 153. The recess 153 may be substantially the same size and shape of the battery 170. In some embodiments, the battery 170 is disposed with the recess 153 of the liquid reservoir 150. In some embodiments, the battery 170 is secured within the recess 153 of the liquid reservoir 150 with a first band 196.

The shelf 151 may be located near the top portion 156 of the liquid reservoir 150 and may be configured to support the pump 180. In some embodiments, the pump 180 is disposed on the shelf 151 of liquid reservoir 150 such that the pump 180 is secured within the electronic sprayer 100. In some embodiments, the pump 180 may be secured to the shelf 151 of the liquid reservoir 150 via a securing coupler 182. In some embodiments, the securing coupler 182 is configured to engage with the shelf 151 of the liquid reservoir 150. In some embodiments, the securing coupler 182 is secured to the shelf 151 with a second band 198.

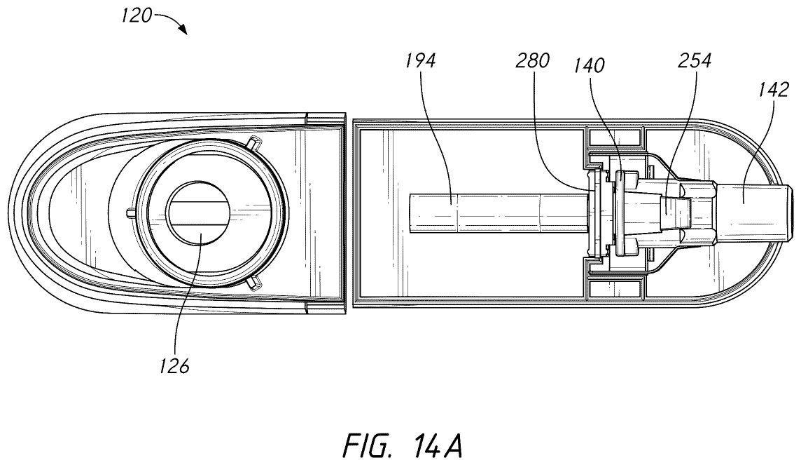

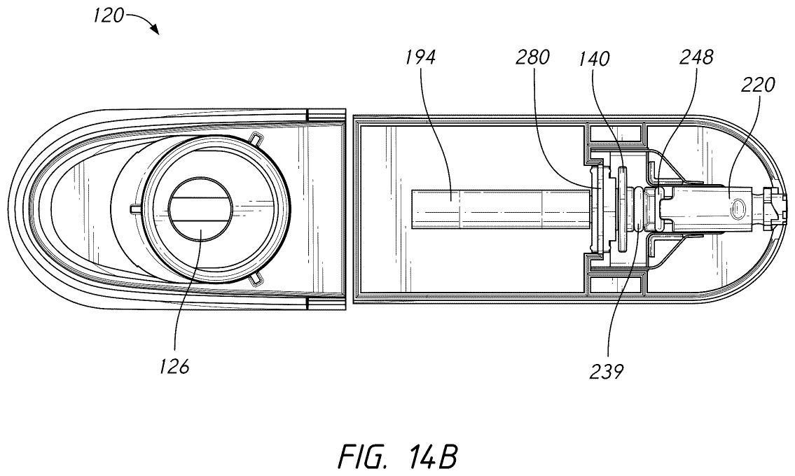

As seen in FIG. 6, the sensor 160 may be disposed directly beneath the top of the outer housing 110 on a front side 102 of the electronic sprayer 100 in the neck region that is configured to be grasped by the user. The sensor 160 can be positioned on the housing 110 such that it is configured to be actuated by an index finger of the user. The sensor 160 may be electrically connected to the battery 170. In some embodiments, the sensor 160 is electrically connected to a controller 190 (as seen in FIG. 14). The sensor 160 is configured to sense pressure applied to an outer surface of the outer housing 110 where the sensor 160 is located. In some embodiments, the sensor 160 may be able to sense a minimal amount of pressure being applied to the outer housing 110. In some embodiments, upon sensing pressure being applied to the front side 102 of the sprayer 100 where the sensor 160 is located, the sensor 160 may be configured to send a signal to the battery 170. In some embodiments, the sensor 160 is configured to send a signal to the controller 190. In some embodiments, as shown, the housing 110 does not include any opening, button, aperture, membrane, or gap in the region surrounding and adjacent to the sensor 160. Rather, the surface of the housing 110 can be continuous and integral in the region surrounding and adjacent to the sensor 160. In this way, liquid, mist, or moisture cannot enter the housing 110 in the region of the sensor 160.

As seen in FIGS. 6-7, the sensor 160 comprises a spring 162 and a plate 164. The plate 164 may be coupled to the pump 180. In some embodiments, the plate 164 is secured to a sensor housing 166. In some embodiments, the sensor 160 is configured to generate an electrical signal upon the plate 164 being contacted by the spring 162.

The sensor housing 166 may be disposed around the pump 180. The sensor housing may act to secure the spring 162 and the plate 164 to the pump 180.

The spring 162 may be disposed between the plate 164 and the outer housing 110. In some embodiments, when pressure is applied to a front side 102 of the electronic sprayer 100 near the neck 114 of the outer housing 110, the spring 162 contacts the plate 164, thereby causing the sensor 160 to generate an electronic signal. In some embodiments, the electronic signal is sent directly to the battery 170. In some embodiments, the electronic signal is sent to a controller 190.

The battery 170 is disposed within the outer housing 110 of the electronic sprayer 100. In some embodiments, the battery 170 is disposed within a recess 153 of the liquid reservoir 150. In some embodiments, the battery may be secured within the recess 153 of the liquid reservoir by a first band 196. The battery 170 may be electrically connected to the charging disc 136. The battery 170 can be rechargeable. The battery 170 is configured to receive electrical power from the charging disc 136 and store the electrical power received. In some embodiments, the battery 170 is a lithium-ion battery. The battery 170 may be electrically connected to the pump 180. Upon receiving a signal, the battery 170 is configured to transfer stored electrical power to the pump 180. In some embodiments, the battery 170 is configured to receive a signal from a controller. In some embodiments, the battery 170 is configured to receive a signal from the sensor 160.

The pump 180 is disposed within the outer housing 110 of the sprayer 100. In some embodiments, the pump 180 is disposed on the shelf 151 of the liquid reservoir 150. In some embodiments, the pump 180 may be secured to a securing coupler 182. In some embodiments, the securing coupler 182 may be configured to engage with the shelf 151 of the outer housing 110. In some embodiments, the securing coupler 182 is secured to the outer housing 110 via the second band 198.

The pump 180 may comprise a pump inlet, a pump outlet, and a motor 188. The pump inlet may be in fluid communication with the liquid reservoir 150 and with the interior of the pump 180. In some embodiments, the pump inlet is fluidly connected to the liquid reservoir 150 via a first tube 192. The pump outlet is in fluid connection with the interior of the pump 180 and with the nozzle 140. In some embodiments, the pump outlet is fluidly connected to the nozzle 140 via a second tube 194.

The motor 188 is electrically connected to the battery 170. Upon receiving power from the battery 170, the motor 188 is configured to activate thereby causing fluid to flow from the liquid reservoir 150 through the pump 180 and to the nozzle 140.

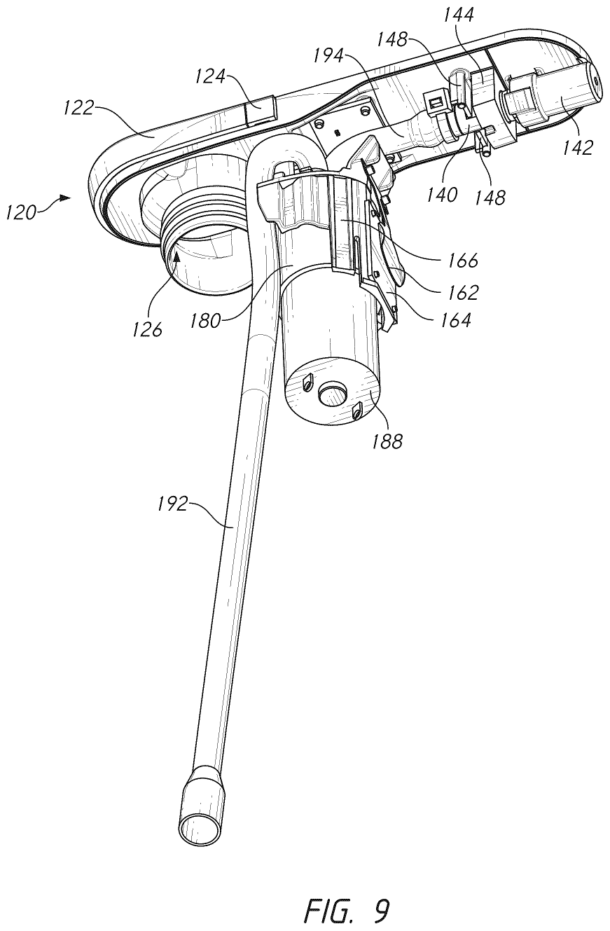

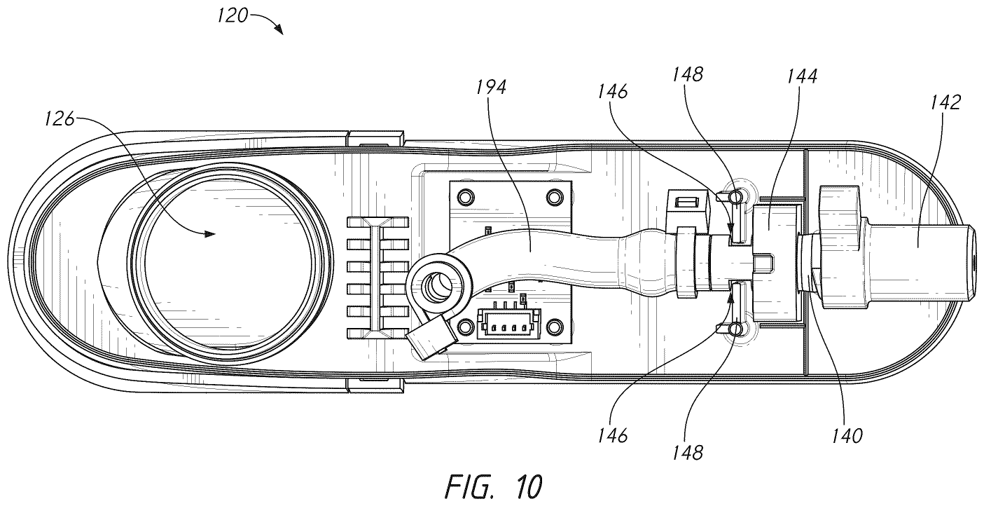

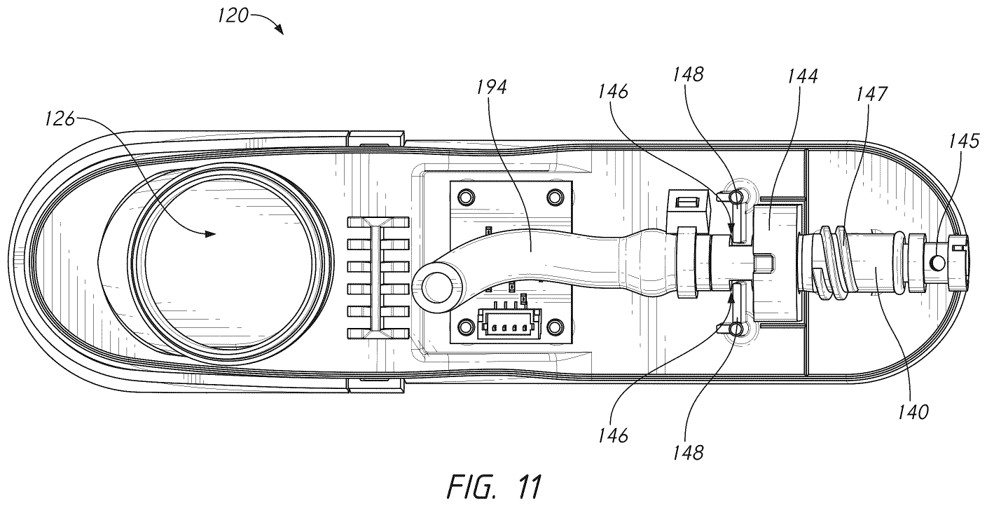

FIGS. 9-11 show various views of the electronic sprayer 100 with various components removed for clarity purposes. FIG. 9 shows a bottom isometric of the head 120 of the electronic sprayer 100. FIG. 10 shows a bottom view of the head 120 of the electronic sprayer 100. FIG. 11 shows a bottom view of the head 120 of the electronic sprayer 100 with the nozzle actuator 142 removed.

As seen in FIG. 9, the nozzle 140 may be in fluid communication with the pump 180, via a second tube 194. In some embodiments, the nozzle 140 comprises a nozzle actuator 142. Fluid flows from the pump 180 to the nozzle 140 and is transmitted through an actuator orifice 143 of the nozzle actuator 142.

As seen in FIGS. 9-11, the nozzle 140 may be secured to the head 120 of the electronic sprayer 100 via a sealing block 144. The sealing block 144 may be connected to the head 120 of the electronic sprayer 100. The sealing block 144 may encompass at least a portion of the nozzle 140, thereby preventing the nozzle 140 from moving away from the head 120.

In some embodiments, the nozzle 140 may comprise a plurality of notches 146. The plurality of notches 146 may be configured to engage with a plurality of stops 148. The plurality of stops 148 may be connected to the head 120 of the electronic sprayer 100 and may be disposed within the plurality of notches 146. The plurality of stops 148 may prevent the nozzle 140 from moving along the length of the head 120. The plurality of stops 148 may work together with the sealing block 144 to prevent or inhibit the movement of the nozzle 140.

As seen in FIG. 11, the nozzle 140 may comprise at least one nozzle orifice 145. Fluid may flow from the pump 180 to the nozzle 140, via the second tube 194, and exit the nozzle 140 via the at least one nozzle orifice 145.

The nozzle actuator 142 may be disposed on the nozzle 140. In some embodiments, the nozzle actuator 142 may be configured to control or adjust the spray profile of the liquid exiting the actuator orifice 143. In some embodiments, the nozzle actuator 142 restricts or prevents liquid from exiting the at least one nozzle orifice 145 of the nozzle 140. By restricting the liquid flow through the at least one nozzle orifice 145 of the nozzle 140, the nozzle actuator 142 may adjust or control the spray profile of liquid exiting the actuator orifice 143.

In some embodiments, the nozzle actuator 142 is able to rotate along a central axis of the nozzle 140. In some embodiments, the nozzle actuator 142 is able to rotate approximately 45° along the central axis of the nozzle 140. The nozzle actuator 142 may be configured to rotate between a first position and a second position. In the first position, the nozzle actuator 142 may not inhibit or restrict the flow of liquid exiting the at least one nozzle orifice 145. In some embodiments, when the nozzle actuator 142 is in the first position, the spray profile of the liquid exiting the electronic sprayer 100 is the least restrictive. In a second position, the nozzle actuator 142 may prevent or restrict the liquid exiting the at least one nozzle orifice 145 such that no liquid exits the nozzle orifice 145 or such that only a small amount of liquid exits the nozzle orifice 145. In some embodiments, when the nozzle actuator 142 is in the second position, the spray profile of the liquid exiting the electronic sprayer 100 is the most restrictive. In some embodiments, the nozzle actuator 142 may be in a plurality of positions between the first and second position that restrict or inhibit the liquid exiting the at least one nozzle orifice 145 to varying degrees.

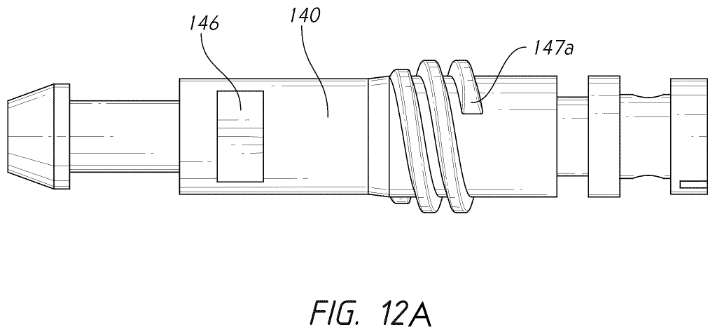

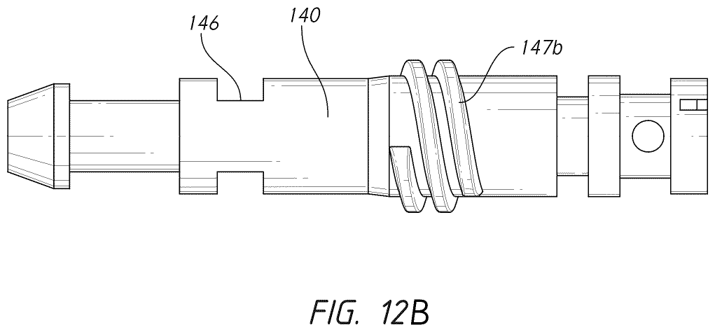

FIGS. 12A-12B show various views of a nozzle 140 according to the above embodiments. FIG. 12A is a top view of a nozzle for an electronic sprayer 100. FIG. 12B shows a bottom view of a nozzle 140 for an electronic sprayer 100. As seen in FIGS. 12A-12B, the nozzle 140 may comprise a multi-start thread 147. A first thread 147a may begin on the top of the nozzle 140, as seen in FIG. 12A. A second thread 147b may begin on the bottom side of the nozzle 140, as seen in FIG. 12B. The multi-start thread 147 may be beneficial for allowing the nozzle actuator 142 to rotate from the first position to the second position with less than or equal to about 180° rotational movement, or less than or equal to about 90° rotational movement, such as a rotational movement of only about 45° or less.

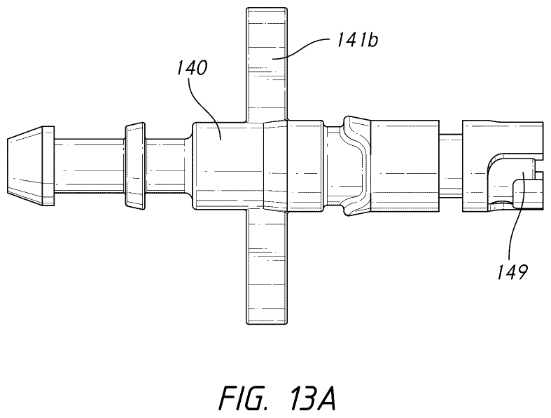

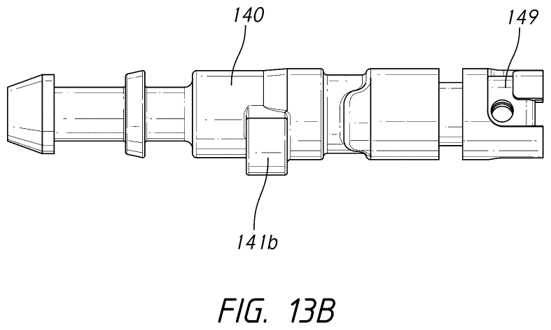

FIGS. 13A-13B show various views of another nozzle 140 according to the above embodiments. FIG. 13A is a top view of a nozzle for an electronic sprayer 100. FIG. 13B shows a side view of a nozzle for an electronic sprayer 100. As seen in FIGS. 13A and 13B, the nozzle 140 may include at least one wing 141 configured to be attached to the head 120 of the electronic sprayer 100. In some embodiments, the at least one wing 141 secures the nozzle 140 to the head 120 of the electronic sprayer 100. In some embodiments, the nozzle 140 may include a groove 149. The groove 149 may be configured to interact with the nozzle actuator 142. Additionally, the nozzle orifice 145 may be positioned within the groove 149. The groove 149 may be configured to guide a portion of the nozzle actuator 142 between at least two positions. In a first position, the nozzle actuator 142 may constrict or block the liquid exiting the nozzle orifice 145 such that no liquid exits the actuator orifice 143 or such that the spray profile of liquid leaving the actuator orifice 145 is restrictive. In a second position, the nozzle actuator 142 may allow liquid to exit the nozzle orifice 145 or the actuator orifice 143 freely such that the spray profile of liquid leaving the actuator orifice 145 is less restrictive than in the first position.

FIGS. 14A and 14B shows various views of an embodiment of the electronic sprayer 100 with various components removed for clarity purposes. FIG. 14A shows a bottom view of the head 120 of the electronic sprayer 100. FIG. 14B shows a bottom view of the head 120 of the electronic sprayer 100 with the nozzle actuator 142 removed.

As seen in FIG. 14A, the nozzle 140 may be in fluid communication with the pump 180, via a second tube 194. The fluid flows through the second tube 242 past an outer seal 280 into the nozzle 140. The fluid then flows through the nozzle 140 and the shuttle 220 until it exits the electronic sprayer 100 through the nozzle actuator 142. The outer seal 280 is configured to contact the second tube 194 and prevent or impede fluid from leaking out the second tube 194.

The outer seal 280 is largely rectangular in shape. In some embodiments, the seal 246 may be another shape, such as, but not limited to, a square, triangle, circle, oval, pentagon, half-circle, or other shape. The outer seal 280 is configured to serve as a stop for the second tube 194 when the second tube 194 is disposed on the nozzle 140. In some embodiments, the outer seal 280 also serves to prevent a fluid from leaking from the second tube 194 or from the nozzle 140 at a first end 242 of the nozzle 140.

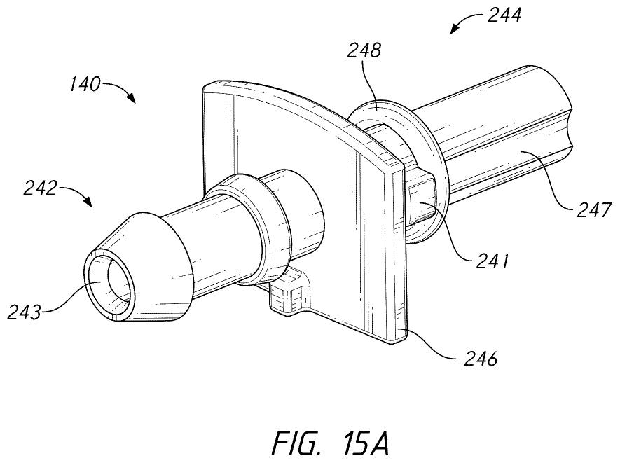

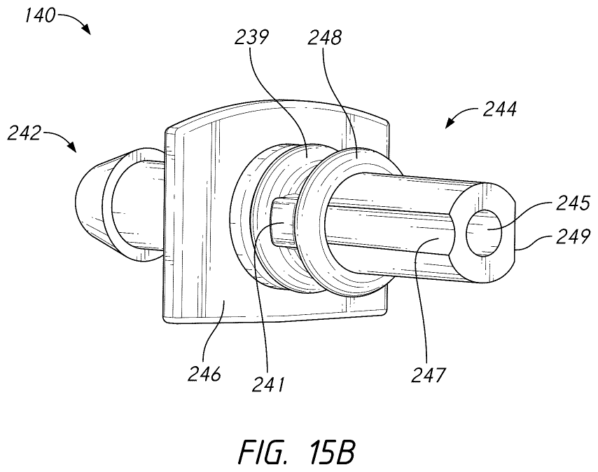

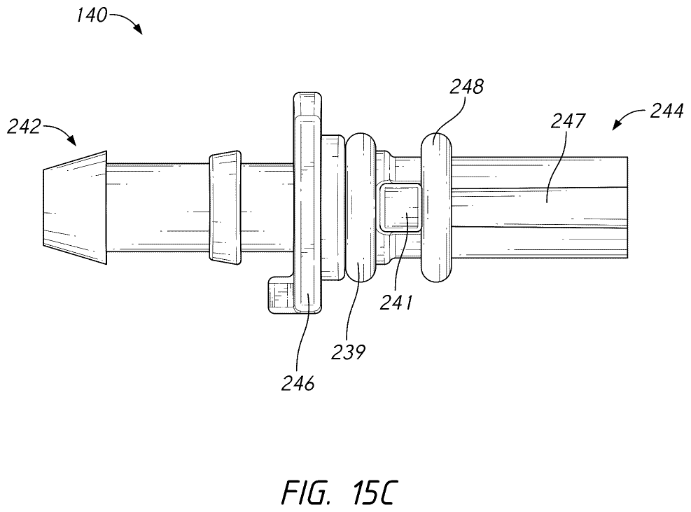

FIGS. 15A-15C show various views of an embodiment of the nozzle 140. FIG. 15A shows a rear isometric view of the nozzle 140. FIG. 15B shows a front isometric view of the nozzle 140. FIG. 15C shows a side view of the nozzle 140.

The nozzle 140 may include a first end 242, a second end 244, a seal 246, and at least one biasing agent 248. The first end 242 of the nozzle 140 may include a first orifice 243 which may be configured to interact or engage with a hose or tube, thereby allowing the nozzle 140 to be in fluid communication with the pump 180. The second end 244 includes an orifice 245 configured to interact with or engage with the shuttle 220, thereby allowing the nozzle 140 to be in fluid communication with the shuttle 220 and the nozzle actuator 142. In some embodiments, the second end 244 includes a guide 247 and a flat edge 249 to assist in correctly orienting a shuttle 220 on the nozzle 140. The guide 247 may be a semicircular indent in the second end 244 of the nozzle 140. The guide 247 is configured to receive the guide bump 223 of the shuttle 220.

The seal 246 is largely rectangular in shape. In some embodiments, the seal 246 may be another shape, such as, but not limited to, a square, triangle, circle, oval, pentagon, half-circle, or other shape. The seal 246 is configured to serve as a stop for the nozzle actuator 142 when the nozzle actuator 142 is disposed over the shuttle 220 and the nozzle 140. In some embodiments, the seal 246 also serves to prevent a fluid from leaking from the nozzle actuator 142 or from the shuttle 220 at a first end 251 of the nozzle actuator 142. In some embodiments, the seal may not contact the nozzle actuator 142 and instead may serve to secure the outer seal 280 and prevent the outer seal 280 from moving laterally away from the second tube 194.

The at least one biasing agent 248 may be disposed on the second end of the nozzle 140 near the seal 246. In some embodiments, the biasing agent 248 may be elastomeric or resilient, such as a spring, or other object configured to exert a biasing force. In some embodiments, the biasing agent 248 is an o-ring. The biasing agent 248 is configured to exert a biasing force on the shuttle 220, when the shuttle 220 is laterally displaced towards the seal 246.

In some embodiments, the nozzle 140 includes at least one stop 241. In some embodiments, there are two stops 241 located on each side of the nozzle 140. The at least one stop 241 can be a protrusion located adjacent to the biasing agent 248. The at least one stop 241 can be configured to prevent the biasing agent 248 from moving laterally towards the seal 246. When a force is applied to the biasing agent 248, the biasing agent 248 is prevented from moving in the lateral direction towards the seal 246 and instead is deformed or compressed, resulting in a biasing force in the opposite direction being created.

In some embodiments, the nozzle 140 includes a ring 239. In some embodiments, the ring 239 serves one or more of the same functions as the seal 248 or outer seal 280. In some embodiments, the nozzle actuator 142 is disposed on the nozzle 140 and shuttle 220 until it contacts the ring 239 which prevents the nozzle actuator from laterally moving towards the seal 246. In some embodiments, the ring 239 also serves to prevent a fluid from leaking from the nozzle actuator 142 or from the shuttle 220 at a first end 251 of the nozzle actuator 142.

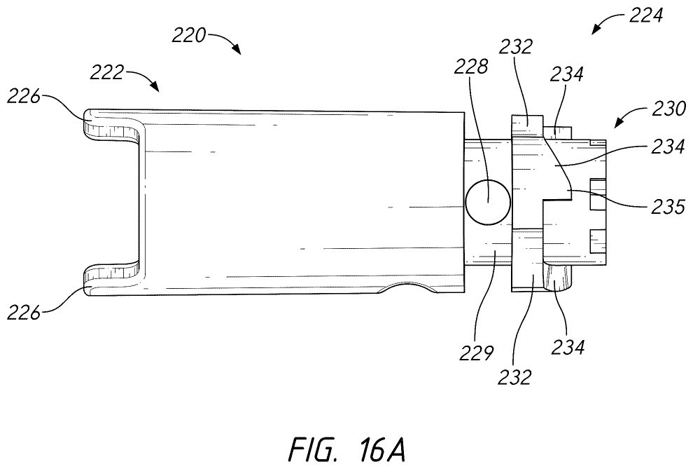

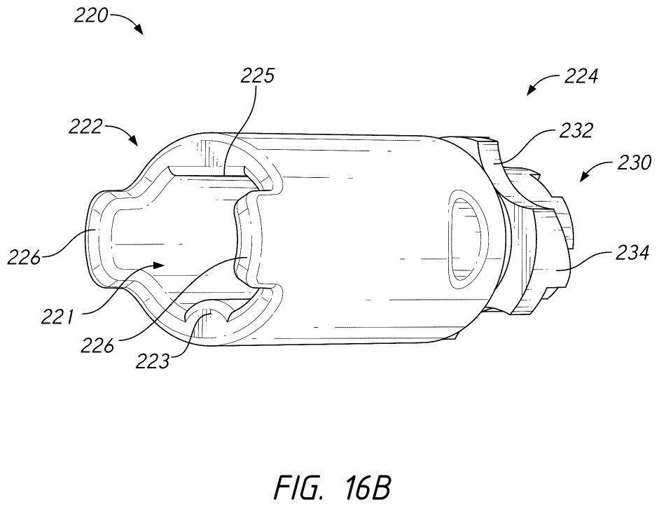

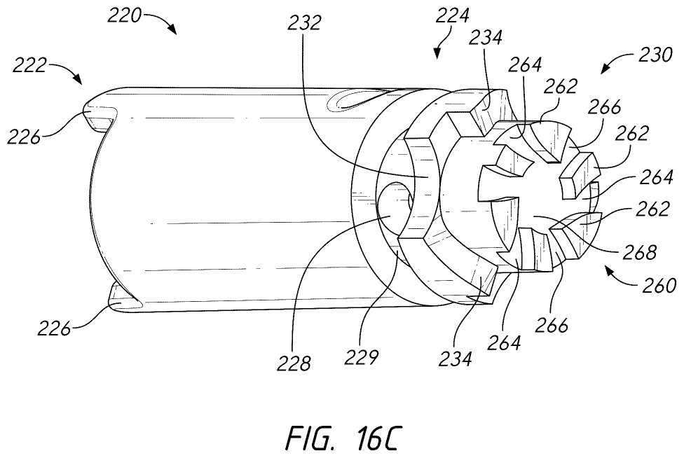

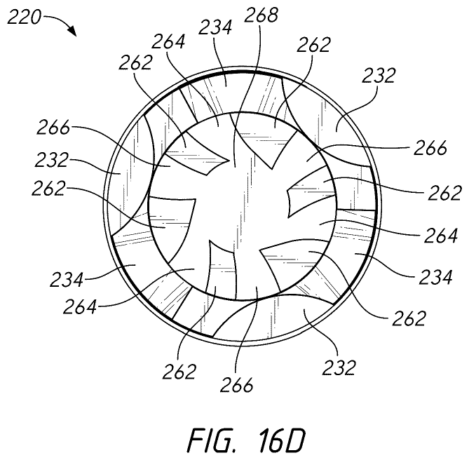

FIGS. 16A-16D show various views of an embodiment of the shuttle 220. FIG. 16A shows a side view of a shuttle 220. FIG. 16B shows a rear isometric view of the shuttle 220. FIG. 16C shows a front isometric view of the shuttle 220. FIG. 16D shows a front view of the shuttle 220.

As seen in FIG. 16A, the shuttle 220 may include a first end 222, a second end 224, at least one contact 226, and at least one orifice 228, a canyon 229 (such as a gap, recess, or groove), and a head 230.

The first end 222 is configured to receive the second end 244 of the nozzle 140. As seen in FIG. 16B, the first end 222 includes an opening 221 where the nozzle 140 is configured to be inserted. The opening 221 may include a guide bump 223 and a flat edge 225. The guide bump 223 may be semi-circular in shape and be configured to engage with the guide 247 of the nozzle 140. The flat edge 225 may be configured such that the flat edge 249 of the nozzle 140 contacts the flat edge 225 of the shuttle 220 when the second end 244 of the nozzle 140 is inserted into the shuttle 220. The combination of the guide bump 223 and the flat edge 225 may serve to help position the shuttle 220 on the nozzle 140 in a certain orientation and to resist positioning the shuttle 220 on the nozzle 140 incorrectly.

The at least one contact 226 is disposed on the first end 22 of the shuttle 220. In some embodiments, there are two contacts 226 one on each side of the shuttle 220. The contacts 226 are configured to contact the biasing agent 248 of the nozzle 140. When the shuttle 220 laterally moves towards the seal 246 of the nozzle 140, the contacts 226 exert a force on the biasing agent 248 towards the seal 246 thereby causing the biasing agent 248 to compress or deform.

The at least one orifice 228 is located within a canyon 229 of the shuttle 220. The channel may be located in between the first end 222 and the second end 224 of the shuttle 220. In some embodiments, the canyon 229 is located near or at a central midpoint of the shuttle 220. In some embodiments, the shuttle 220 includes two orifices 228, one on each side of the shuttle 220. Fluid entering the shuttle 220 from the second end 244 of the nozzle 140 exits the shuttle 220 through the orifices 228.

The head 230 is located at the second end 224 of the shuttle 220. The head 230 may be located adjacent to the canyon 229. The head 230 may include at least one channel 232, at least one ramp 234, and a spin chamber 260.

The at least one channels 232 are located on the head 230 such that the channels 232 are adjacent to the canyon 229. The at least one channels 232 are configured to allow fluid exiting the shuttle 220 from the orifices 228 to flow through the channels 232 and thereby towards the spin chamber 260. In some embodiments, the channels 232 may be semi-circular indents in the head 230 of the shuttle. In some embodiments, the shuttle 220 includes a plurality of channels 232. In some embodiments, the shuttle 220 includes 2, 3, 4, 5, 6, 7, 8, 9, or 10 channels 232. In some embodiments, the channels 232 are spaced along the perimeter of the head 230 such that the distance between adjacent channels 232 is approximately equal. In some embodiments, the channels 232 are spaced along the perimeter of the head 230 such that the distance between adjacent channels 232 is not equal.

The ramps 234 are located on the head 230 of the shuttle 220. In some embodiments, the ramps 234 are located adjacent to the channels 232. The ramps 234 are configured to engage with ramps 256 of the nozzle actuator 142. Specifically, a high end 235 of the ramp 234 contacts a high end 257 of a ramp 256 on the nozzle actuator 142, thereby causing the ramps 256 of the nozzle actuator 142 to exert a force towards the seal 246 of the nozzle 140 on the ramps 234 of the shuttle 220 and therefore on the shuttle 220 itself. The force exerted causes the shuttle 220 to move laterally towards the seal 246, thus causing the contacts 226 to compress or deform the biasing agent 248.

The spin chamber 260 located on the head 230 of the shuttle 220 at a second end 224 of the shuttle 220. The spin chamber 260 includes a plurality of protrusions 262, a first subset of passages 264, a second plurality of passages 266, and a central area 268. The spin chamber 260 is configured to control or adjust the spray profile of fluid leaving the electronic sprayer 100 though the nozzle actuator 142.

The plurality of protrusions 262 are location on the second end 224 of the shuttle 220 and form the first and second subsets of passages, 264 and 266. As seen in FIGS. 16C-D, the plurality of protrusions 262 may include protrusions of different shapes and sizes. In some embodiments, the protrusions 262 may include protrusions with a square shape, a triangular shape, a circular shape, an oval shape, or other shape. As seen in FIGS. 16C-D, the spaces between adjacent protrusions 262 form at least a first and second subset of passages 264, 266 which lead to the central area 268. The first and second passages 264, 266 are configured to cause fluid flowing through the passages 264, 266 to swirl or circle with the central area 268. The swirling motion causes the fluid to experience a centrifugal force radially away from the central area 268, which in turns causes the fluid to atomize or to break up into smaller droplets. The size and shape of the droplets affects the spray profile of fluid exiting the nozzle actuator 142.

As seen in FIGS. 16C-16D, the first subset of passages 264 is in fluid communication with the channels 232 and with the central area 248. The first subset of passages 264 is situated such that the angle of entry of fluid entering the central area 268 is relatively high, thereby causing the fluid to enter the central area 268 with a higher angular velocity, thereby increasing the centrifugal forces the fluid experiences within the central area 268. This ultimately results in the fluid exiting the electronic sprayer 100 in a fine spray.

In some embodiments the first subset of passages 264 are positioned along the edge of the spin chamber 260 such that the angle between each passage 264 is equal. In some embodiments the first subset of passages 264 are positioned along the edge of the spin chamber such that the angle between each passage 264 is not equal.

The second subset of passages 266 are situated such that the angle of entry of fluid entering the central area 268 is lower than that of the first subset of passages 264, thereby causing the fluid to enter the central area 268 with a lower angular velocity, thereby decreasing the centrifugal forces the fluid experiences within the central area 268. This ultimately results in the fluid exiting the electronic sprayer 100 in a coarse spray.

In some embodiments the second subset of passages 266 are positioned along the edge of the spin chamber 260 such that the angle between each passage 266 is equal. In some embodiments the second subset of passages 266 are positioned along the edge of the spin chamber such that the angle between each passage 266 is not equal.

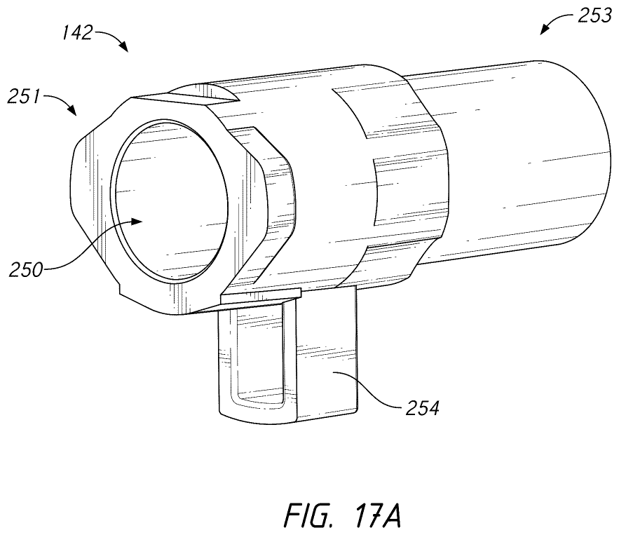

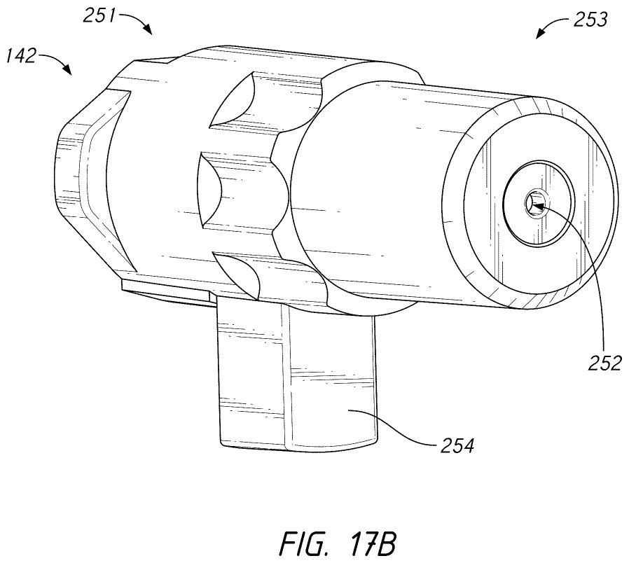

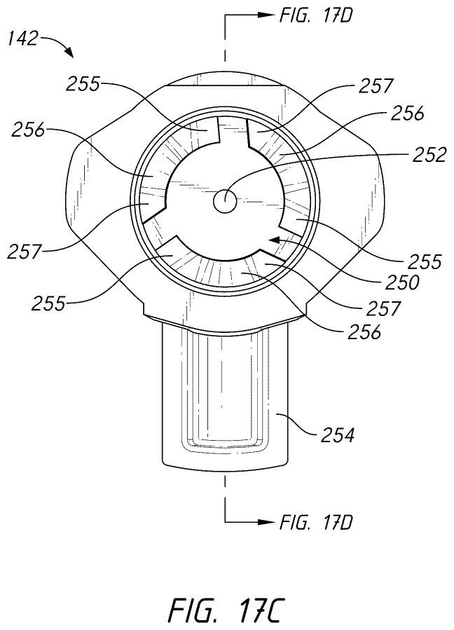

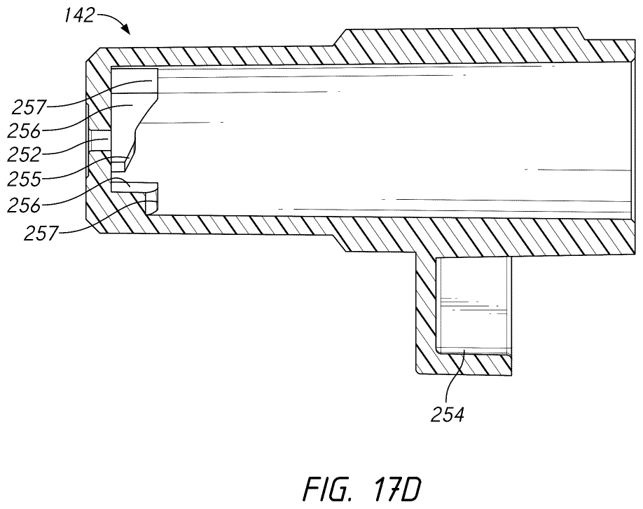

FIGS. 17A-17D shows various views of an embodiment of a nozzle actuator 142. FIG. 17A shows a rear isometric view of the nozzle actuator 142. FIG. 17B shows a front isometric view of the nozzle actuator 142. FIG. 17C shows a rear view of the nozzle actuator 142. FIG. 17D shows a side cross-sectional view of the nozzle actuator 142.

The nozzle actuator 142 has an opening 250, an orifice 252, a lever 254, and at least one ramp 256. The opening 250 is located at a first end 251 of the nozzle actuator 142 and is configured to receive the shuttle 220 and the nozzle 140. The opening 250 is configured such that when the shuttle 220 is disposed with the nozzle actuator 14, fluid exiting the orifices 228 of the shuttle 220 does not exit the nozzle actuator 142 via the opening 250 or at least only a small amount of fluid exits the nozzle actuator 142 via the opening 250. The opening 250 is further configured such that when the shuttle 220 is disposed with the nozzle actuator 14, all of the fluid or a substantial amount of the fluid exiting the orifices 228 of the shuttle 220 is forced through the channels 232 of the shuttle 220.

The orifice 252 is located at a second end 253 of the nozzle actuator 142. Fluid exits the nozzle actuator 142 via the orifice 252.

The one or more ramps 256 are located within the opening 250 of the nozzle actuator 142 near a second end 253 of the nozzle actuator 142. The ramps 256 may be located adjacent to the outer perimeter of the opening 250. In some embodiments, the number of ramps 256 is equal to the number of passages in the first or second subset of passages 264, 266 of the shuttle 220. The ramps 256 protrude outward from a bottom side of the surface where the orifice 252 is located. The ramps 256 are configured such that the when the shuttle 220 is disposed with the nozzle actuator 142 the ramps 256 block the first or second subsets of passages 264, 266 of the shuttle 250 and prevent fluid from entering the blocked passages. Each ramp 256 may have a low end 255 and a high end 257. The ramp 256 is further configured to engage with the ramps 234 of the shuttle 220, such that when the nozzle actuator 142 is rotated a certain direction the high end 257 of the ramp 256 of the nozzle actuator 142 contacts the high end 235 of the ramps 234 of the shuttle 220, thereby causing the ramps 256 to exert a force on the shuttle 220 and push the shuttle 220 in a lateral direction towards the scal 246.

The lever 252 is disposed on a bottom side of the nozzle actuator 142. The lever 252 is configured such that a user can rotate the lever 252 and thereby rotate the nozzle actuator 142. In some embodiments, the position of the lever 252 affects the spray profile of the fluid exiting the electronic sprayer 100. In some embodiments, the lever 252 may be rotatable between three positions. In some embodiments, the level 252 is rotatable between two positions or between more than three positions. In some embodiments, the three positions are located approximately the same angular distance away from each other, such as less than or equal to about 60°, or less than or equal to about 50°, or about 45°, away from each other. In some embodiments, the three positions may not be equally spaced apart.

When the lever 252 is in a first position, the ramps 256 of the nozzle actuator 142 may block the second subset of passages 266 of the spin chamber 260, preventing fluid from entering the second subset of passages 266 and thereby forcing a substantial amount of fluid exiting the shuttle 200 to flow through the first subset of passages 264 of the spin chamber 26. This causes the fluid to exit the orifice 252 of the nozzle actuator 142 in a fine mist.

When the lever 254 is in a second position, the ramps 256 of the nozzle actuator 142 may block the first subset of passages 264 of the spin chamber 260, preventing fluid from entering the first subset of passages 260 and thereby forcing a substantial amount of fluid exiting the shuttle 220 to flow through the second subset of passages 266 of the spin chamber 260. This causes the fluid to exit the orifice 252 of the nozzle actuator 142 in a coarser mist.

When the lever 254 is in a third position, the ramps 256 of the nozzle actuator 142 contact and engage with the ramps 234 of the shuttle 220, thereby causing the high end 257 of the ramp 256 to push the ramps 234 of the shuttle 220 towards the seal 246. This allows the fluid exiting the shuttle 220 to flow freely out the orifice 252 of the nozzle actuator 142 without passing through the spin chamber 260 of the shuttle 220. The rotation of the level 254 to the third position additionally the contacts 226 of the shuttle 220 to deform or compress the biasing agent 248. This results in the fluid flow being substantially laminar and creates a jet of water exiting the orifice 252.

When the lever 254 is rotated away from the third position, the high ends 257 of the ramps 256 will no longer contact the ramps 234 of the shuttle 220. This removes the force exerted by the ramps 256 on the shuttle 220. In turn, the biasing force exerted by the biasing agent 248 on the contacts 226 of the shuttle 220 causes the shuttle 220 to move laterally towards the second end 253 of the nozzle actuator 142.

Appendix A herein includes an example of an assembly guide for assembly of a nozzle structure as depicted in FIGS. 14A through 17D. Appendix A further includes a series of photographs of an example of the nozzle structure.

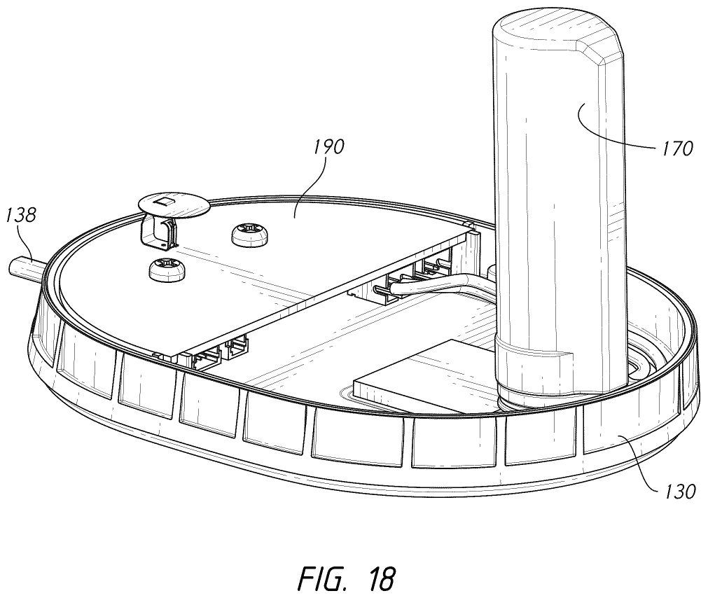

FIG. 18 shows a front isometric view of the base 130 of the electronic sprayer 100. As seen in FIG. 18, the electronic sprayer 100 may comprise at least one controller 190. The at least one controller 190 may be configured to control the flow of electrical power between the charging disc 136 and the battery 170. In some embodiments, the at least one controller 190 controls the flow of electrical power between the charging disc 136 and the battery 170 such that the battery 170 is charged at a constant rate. In some embodiments, the at least one controller 190 controls the flow of electrical power between the charging disc 136 and the battery 170 such that the battery 170 is charged once the battery 170 drops below a threshold charge value.

In some embodiments, the controller 190 may be configured to receive a signal from the sensor 160. Upon receiving a signal from the sensor 160, the controller 190 may be configured to send a signal to the battery 170, thereby causing electrical power to flow from the battery 170 to the pump 180.

In some embodiments, the controller 190 may also function as a sensor. As seen in FIG. 5, the liquid reservoir 150 may be disposed on the controller 190. In some embodiments, the controller 190 senses a pressure applied to the controller 190 by the liquid reservoir 150 and determines the amount of fluid present in the liquid reservoir 150. In some embodiments, the controller 190 may be configured to generate a signal upon the amount of fluid within the liquid reservoir 150 dropping below a threshold value. In some embodiments, the signal may notify a user that the amount of fluid in the liquid reservoir 150 has dropped below the threshold value. According to this configuration, fluid may enter the liquid reservoir 150 via the opening 126 in the head 120 of the sprayer 100. A user of the sprayer 100 may apply a pressure to a front side 102 of the neck 114 of the sprayer 100. The spring 162 of the sensor 160 contacts the plate 164, thereby causing the sensor 160 to generate an electronic signal. In some embodiments, the signal is sent to the controller 190, where the controller 190 will then send a signal to the battery 170 causing the battery 170 to transfer electrical power to the motor 188 of the pump 180. In some embodiments, the signal is sent directly to the battery 170 causing the battery 170 to transfer electrical power to the motor 188 of the pump 180. The pump 180 activates, thereby causing fluid to flow out of the liquid reservoir 150 through the fluid outlet 154 and the first tube 192 and into the pump 180, via the pump inlet. The fluid exits the pump 180 via the pump outlet and travels through the second tube 194 to the nozzle 140. The fluid exits the nozzle 140 via the at least one nozzle orifice 145, where the fluid is forced to exit the sprayer 100 via the actuator orifice 143. The spray profile of the fluid exiting the actuator orifice 143 is controlled by the nozzle actuator 142.

### Terminology and Conclusion

Reference throughout this specification to “some embodiments” or “an embodiment” means that a particular feature, structure or characteristic described in connection with the embodiment is included in at least some embodiments. Thus, appearances of the phrases “in some embodiments” or “in an embodiment” in various places throughout this specification are not necessarily all referring to the same embodiment and may refer to one or more of the same or different embodiments. Furthermore, the particular features, structures or characteristics may be combined in any suitable manner, as would be apparent to one of ordinary skill in the art from this disclosure, in one or more embodiments.

As used in this application, the terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Similarly, it should be appreciated that in the above description of embodiments, various features are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that any claim require more features than are expressly recited in that claim. Rather, inventive aspects lie in a combination of fewer than all features of any single foregoing disclosed embodiment.

A number of applications, publications, and external documents may be incorporated by reference herein. Any conflict or contradiction between a statement in the body text of this specification and a statement in any of the incorporated documents is to be resolved in favor of the statement in the body text.

Terms of equality and inequality (less than, greater than) are used herein as commonly used in the art, e.g., accounting for uncertainties present in measurement and control systems. Thus, such terms can be read as approximately equal, approximate less than, and/or approximately greater than.

While the embodiments of the invention disclosed herein are presently considered to be preferred, various changes and modifications can be made without departing from the scope of the invention. Although described in the illustrative context of certain preferred embodiments and examples, it will be understood by those skilled in the art that the disclosure extends beyond the specifically described embodiments to other alternative embodiments and/or uses and obvious modifications and equivalents. Thus, it is intended that the scope of the claims which should not be limited by the particular embodiments described herein.

The following is claimed:

1. A household sprayer, comprising:
a liquid reservoir configured to store a liquid, the reservoir comprising a top end and a bottom end;
a nozzle in fluid communication with the liquid reservoir, wherein the nozzle is configured to spray liquid;
a nozzle actuator configured to control the spray profile of liquid exiting the nozzle;
a pump in fluid communication with the nozzle and the liquid reservoir, wherein the pump is configured to cause liquid to flow from the liquid reservoir to the nozzle;
a battery comprising a top end and a bottom end, the battery being electrically connected to the pump, wherein the battery is configured to provide power to the pump; and
an outer housing enclosing the liquid reservoir, the pump, and the battery;
wherein the top end of the battery is below the top end of the reservoir.

2. The sprayer of claim 1, further comprising a neck in the outer housing configured to form a grasping portion.

3. The sprayer of claim 2, wherein components of the sprayer are positioned and arranged such that a single imaginary vertical line can intersect each of the liquid reservoir, the pump, and an interior of the grasping portion.

4. The sprayer of claim 3, wherein below the grasping portion the outer housing tapers outwardly from top to bottom.

5. The sprayer of claim 4, wherein the largest cross-sectional area of the housing is positioned at the bottom of the housing.

6. The sprayer of claim 3, further comprising a sensor configured to actuate the spraying of liquid when actuated, the sensor being positioned entirely behind the housing, such that the sensor is not visible from outside of the housing.

7. The sprayer of claim 3, wherein the battery is positioned in a bottom half of the sprayer.

8. The sprayer of claim 7, wherein the battery is positioned at a bottom end of the sprayer.

9. The sprayer of claim 3, wherein the motor, pump, and reservoir are located within a single integral, continuous outer housing.

10. A household sprayer, comprising:
a liquid reservoir configured to store a liquid;
a nozzle in fluid communication with the liquid reservoir, wherein the nozzle is configured to spray liquid;
a nozzle actuator configured to control the spray profile of liquid exiting the nozzle;
a pump in fluid communication with the nozzle and the liquid reservoir, wherein the pump is configured to cause liquid to flow from the liquid reservoir to the nozzle;
a battery electrically connected to the pump, wherein the battery is configured to provide power to the pump;
an outer housing enclosing the liquid reservoir, the pump, and the battery; and
a sensor disposed beneath the outer housing, wherein activating the sensor causes the pump to activate, thereby causing liquid to spray from the nozzle.

11. The sprayer of claim 10, wherein the sensor is disposed underneath the outer housing at a location near a neck of the sprayer.

12. The sprayer of claim 10, wherein the sensor is configured to activate when a user contacts the neck of the outer housing or applies a pressure to the neck of the outer housing.

13. The sprayer of claim 10, wherein the sensor comprises a spring and a metal plate, wherein the spring is disposed between the outer housing and the metal plate.

14. The sprayer of claim 13, wherein contacting the outer housing causes the spring to contact the metal plate, thereby causing the sensor to activate.

15. The sprayer of claim 10, wherein the nozzle actuator controls the spray profile of the liquid exiting the nozzle by restricting the flow of liquid to the nozzle.

16. The sprayer of claim 15, wherein the nozzle actuator is able to rotate less than or equal to about 45° between two positions.

17. The sprayer of claim 10, wherein the nozzle actuator comprises a multi-start thread, wherein the multi-start thread is configured to allow the nozzle to produce a least restrictive spray profile when the nozzle actuator is in a first position and a most restrictive spray profile when the nozzle actuator is in a second position.

18. The sprayer of claim 10, wherein the battery is connected to a base of the sprayer.

19. The sprayer of claim 18, wherein the liquid reservoir is molded such that the battery is partially enclosed by the liquid reservoir.

20. The sprayer of claim 19, wherein the battery is connected to the base of the sprayer at a central location of the base.

21. The sprayer of claim 10, wherein the neck in the outer housing is configured to form a grasping portion.
